(19) United States
(12) Patent Application Publication
(10) Pub. No.: US 2008/0202160 A1
(43) Pub. Date: Aug. 28, 2008

(54) Method and device for fractionated cryocondensation

(76) Inventors: Stefan Wolf, Haar (DE); Hans-Rudolf Himmen, Haimhausen (DE); Hans-Jurgen Reinhardt, Kaufbeuren (DE)

Correspondence Address: The BOC Group, Inc., 575 MOUNTAIN AVENUE, MURRAY HILL, NJ, 07974-2082, US

(21) Appl. No.: 12/006,602

(22) Filed: Jan. 4, 2008

(30) Foreign Application Priority Data
Jan. 11, 2007 (DE) 102007001658.3
Apr. 3, 2007 (EP) 07006971.1

(51) Int. Cl. F25J 3/06; B01D 5/00; B01D 53/00; F25J 5/00

(52) U.S. Cl. 62/617

(57) ABSTRACT

The invention relates to a method and device for the fractionated cryocondensation of a process gas in at least one cooler and a freezer, wherein a specific process temperature is set inside the cooler.

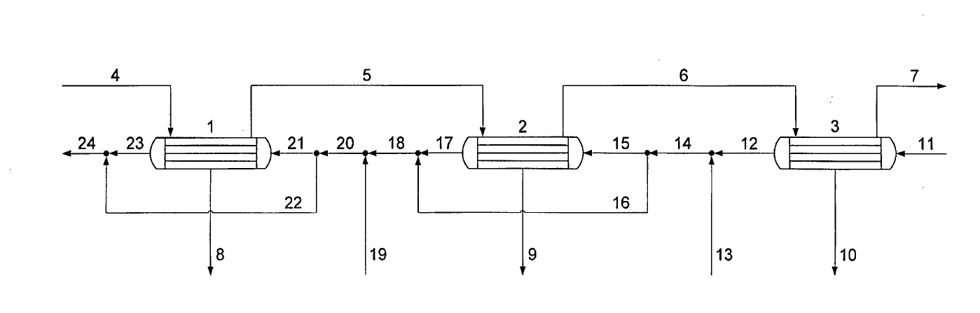

### CROSS REFERENCE TO RELATED APPLICATIONS

This application claims priority from German Patent Application Serial No. 102007001658.3, filed Jan. 11, 2007, and European Patent Application 07006971.1, filed Apr. 3, 2007.

### BACKGROUND OF THE INVENTION

The invention relates to a method for cooling and/or purifying a process gas, wherein the process gas is pre-cooled in a cooler, while undergoing indirect heat exchange with a second coolant stream, wherein condensate arising in the cooler is removed from the cooler, and wherein the process gas exiting the cooler is cooled in a freezer, while undergoing indirect heat exchange with a first coolant stream, wherein condensate arising in the freezer is removed from the freezer, and wherein at least a portion of the first coolant stream exiting the freezer is routed to the cooler to form at least a portion of the second coolant stream.

The invention further relates to a device for cooling and/or purifying a process gas, comprising a cooler designed as an indirect heat exchanger with a process, gas feed line and process gas discharge line, and with a coolant feed line and coolant discharge, a freezer designed as an indirect heat exchanger with a process gas feed line and process gas discharge line, and with a coolant feed line and coolant discharge, wherein the process gas discharge line of the cooler is connected with the process gas feed line of the freezer, wherein the coolant discharge of the freezer is connected with the coolant feed line of the cooler.

During cryocondensation, contents like volatile organic components (VOC) are recovered from a process gas via cooling to low temperatures and condensation. The process gas is here cooled while undergoing indirect heat exchange with a cooling agent.

The process gas is most often cooled while undergoing an indirect heat exchange with a cooling agent in one or more pre-coolers and a freezer. Cold gas, e.g., cold gaseous nitrogen or purified refrigerated process gas, is used as the cooling agent in the pre-cooler(s). Liquid nitrogen is normally used as the cooling agent in the freezer.

Cooling the process gases causes the volatile constituents in the process gas to condense in the individual heat exchangers. The composition of the resultant condensate here depends on the components originally present in the process gas and their composition. The pressure of the process gas and its temperature in the heat exchangers also influence the condensate composition. The condensates obtained in the individual heat exchangers are today combined in a shared accumulating tank and subsequently reused or disposed.

As a rule, the described cryocondensation method is used for cleaning waste gas. The stipulated purity requirements on the process gas can be satisfied by setting the temperature of the process gas in the freezer.

In this method, the pre-coolers are cooled with the already cooled process gas and/or with the cooling agent exiting the freezer, e.g., cold gaseous nitrogen. Therefore, the temperature of the process gas in the pre-coolers is set given prescribed heat exchange surfaces in the pre-coolers. However, the composition of the condensates obtained in the individual pre-coolers is also predetermined as a function of the temperature of the process gas.

The obtained condensate generally exhibits several different components. The condensate must first be purified in a complicated process before these components can be reused.

### BRIEF SUMMARY OF THE INVENTION

Therefore, the object of the invention is to describe a method and device that allow a direct reuse of the components condensed from a process gas in a cryocondensation process.

This object is achieved with a method of the kind mentioned at the outset, which is characterized in that the second coolant stream is regulated in such a way as to keep a preset process gas temperature in the cooler, and accumulate the condensate removed from the cooler and condensate removed from the freezer separately from each other.

The device according to the invention of the type mentioned at the outset is characterized in that the freezer and cooler are provided with a condensate discharge line for removing condensate arising in the freezer or cooler, wherein the condensate discharge line of the freezer is connected with a first condensate container, and the condensate discharge line of the cooler is connected with a second condensate container.

According to the invention, the process gas to be cooled and/or purified is first pre-cooled in a cooler and then cooled in a freezer. The process gas is cooled in the freezer while undergoing indirect heat exchange with a first coolant stream. At least one portion of the first coolant stream exiting the freezer is then routed to the cooler for pre-cooling the process gas, thereby forming at least a portion of the second coolant stream.

According to the invention, the second coolant stream is now controlled in such a way as to keep a prescribed process temperature in the cooler. While cooling the process gas, condensate arises in both the cooler and freezer, which is removed from the cooler or freezer. Setting a specific process gas temperature in the cooler as instructed in the invention makes it possible to influence the composition of the condensate obtained in the cooler in a targeted fashion, e.g., removing a condensate of defined purity from the cooler. The condensates obtained in the cooler or freezer are accumulated separately from each other according to the invention, so that they can be reused without having to be cleaned again.

In a preferred embodiment of the method according to the invention, the process gas is not just cooled in a cooler and downstream freezer, but rather at least one pre-cooler is incorporated upstream from the cooler. The process gas is first pre-cooled in the pre-cooler while undergoing indirect heat exchange with a third coolant stream, then relayed to the cooler and there made to undergo indirect heat exchange with the second coolant stream. Finally, the process gas pre-cooled in this way is cooled to the desired final temperature in the freezer.

In this procedural variant, the third coolant stream that serves as a cooling agent in the pre-cooler is advantageously also regulated in such a way as to set a prescribed process gas temperature in the pre-cooler. Just as the cooler and freezer, the pre-cooler has a condensate discharge, so that condensate that arises during pre-cooling or cooling or freezing can be removed and discharged to three separate condensate containers. Influencing the process gas temperature according to the invention during pre-cooling or cooling and freezing makes it possible to obtain a respective condensate with a specific composition in the pre-cooler, cooler and freezer.

Of course, similarly to the procedure described above with a pre-cooler, it is also possible to use several pre-coolers, which are sequentially traversed by the process gas, wherein the temperature of the process gas is preferably set in a defined manner according to the invention in each of the pre-coolers.

Pre-coolers, coolers and freezers are in the following also referred to generally as heat exchangers.

The process gas temperature is preferably regulated and set in the cooler by supplying another cooling agent or heat transfer medium stream to the first coolant stream exiting the freezer. The additional cooling agent or heat transfer medium stream and the first coolant stream exiting the freezer then form a second coolant stream, which enters into indirect heat exchange with the process gas in the cooler. Supplying another cooling agent or heat transfer medium makes it possible to set the temperature and quantity of the second coolant stream based on the requirements desired. For example, supplying a cooling agent stream makes it possible to lower the temperature of the second coolant stream, and increase it by supplying a heat transfer medium.

The step of supplying a cooling agent or heat transfer medium stream for setting the process gas temperature can be utilized in a similar way during the use of a cryocondensation system with pre-cooler, cooler and freezer. In this case, the process gas temperature in the pre-cooler is specifically set by adding the cooling agent or heat transfer medium to the second coolant stream exiting the cooler, and passing the third coolant stream arising in this way through the pre-cooler.

In the described method, the cooling agent or heat transfer medium is mixed or added directly to the coolant stream entering the cooler or freezer. The advantage to this is that the cooler or freezer requires no separate passages for routing through the cooling agent or heat transfer medium. However, if the coolant stream is to be used for a different purpose after cryocondensation, for example, intertization, it is generally necessary in this case that the same substance be used for the coolant stream and cooling agent or heat transfer medium, i.e., nitrogen, respectively.

Given certain initial conditions, it is advantageous to use a cooling agent or heat transfer medium deviating from the coolant stream, wherein it is also possible to route the cooling agent or heat transfer medium through the cooler or pre-cooler separately from the coolant stream. This approach is associated with the same advantages relative to setting the process gas temperature in the pre-cooler or cooler. However, this case requires that separate passages through the cooler or pre-cooler be provided for the cooler or heat exchanger.

Instead of or in addition to supplying the other cooling agent or heat transfer medium, it may be advantageous to set the temperature conditions in the cooler or pre-cooler by adjusting the quantity of the coolant stream supplied to the cooler or pre-cooler. To this end, the entire first coolant stream exiting the freezer is preferably not sent to the cooler, but rather a portion of the first coolant stream exiting the freezer is routed by the cooler via a bypass. As a result, the temperature of the process can be controlled in the cooler by regulating the quantity of second coolant stream. When using a pre-cooler, the process gas temperature in the pre-cooler can be controlled in a corresponding manner by routing a portion of the second coolant stream exiting the cooler by the pre-cooler via a bypass.

A gaseous or liquid medium brought to a corresponding temperature, in particular gaseous or liquid nitrogen, can be used as the cooling agent or heat transfer medium. It has also proven beneficial to use process gas removed from the freezer and cooled as cooling agents or heat transfer media in the cooler and/or pre-cooler.

The process gas temperatures in the pre-cooler and/or cooler and/or freezer are advantageously selected in such a way that ice forming in the pre-cooler and/or cooler and freezer becomes distributed in a defined manner on the pre-cooler and/or cooler and/or freezer, i.e., the ability of the pre-cooler, cooler and freezer to accommodate freezing water can as a result be optimally utilized, and one of the heat exchangers—the pre-cooler, cooler or freezer—is prevented form rapidly freezing shut. This tangibly increases the service life of the entire cryocondensation system. In addition, a redundant design of individual heat exchangers or the entire cryocondensation system can under certain conditions be omitted, making it possible to substantially reduce investment costs.

The invention as well as other advantageous embodiments of the invention will be described in greater detail based on the FIGURE. The FIGURE here shows the schematic flowchart for a cryocondensation system according to the invention.

### BRIEF DESCRIPTION OF THE DRAWING

The FIGURE shows a system for cooling and/or purifying a process gas.

### DETAILED DESCRIPTION OF THE INVENTION

The system shown on the FIGURE exhibits a pre-cooler 1, a cooler 2 and a freezer 3. A process gas stream 4, 5, 6, 7 to be purified and cooled is consecutively passed through the pre-cooler 1, cooler 2 and freezer 3, and cooled in stages. In each of the three heat exchangers 1, 2, 3, a condensate 8, 9, 10 varying in respective composition is here obtained.

The process gas 4, 5, 6 is cooled in the heat exchangers 1, 2, 3 using liquid nitrogen 11, which is first supplied to the freezer 3, and then passes through the heat exchangers 2 and 1, wherein the latter is evaporated and warmed. In addition, another cooling agent/heat transfer medium stream 13, 19 is used for adjusting the temperature of the process gas stream 4, 5, as will be explained in greater detail below.

The process gas 4 is cooled to a specific temperature in the pre-cooler 1, wherein a condensate 8 with a defined composition is obtained. Cold, gaseous nitrogen 17, 18 exiting the cooler 2 is used as the coolant stream. In order to precisely set the temperature necessary for cryocondensation in the pre-cooler, liquid nitrogen 19 is admixed to the cold, gaseous nitrogen 18. The third coolant stream 20 formed via this admixing step cools the process gas 4 in the pre-cooler to the temperature necessary for cryocondensation. Without admixing the cooling agent 19, the required low process gas temperature in the pre-cooler 1 could not be reached via the coolant stream 17, 18 exiting the cooler 2 alone.

If the second coolant stream 17, 18 exiting the cooler 2 exhibits too low a temperature, a heat transfer medium 19, e.g., warm, gaseous nitrogen, can be admixed to the coolant stream 18 instead of a cooling agent.

As an alternative and/or in addition to the described admixing of a cooling agent or heat transfer medium 19, only a partial stream 21 of the coolant stream 20 can be passed through the pre-cooler 1 instead. The remaining partial stream 22 is in this case routed by a pre-cooler 1 via a bypass, and then reintroduced to the coolant stream 23 exiting the pre-cooler 1.

The preset process gas temperature in the pre-cooler 1 is maintained according to the invention via the quantity and/or temperature of metered cooling agent/heat transfer medium 19 and/or by regulating the partial coolant streams 21, 22.

The condensate 8 is removed from the pre-cooler 1 and accumulated in a first condensate container not shown in the drawing. The condensate 8 can again be directly introduced to the production process at another point, for example.

Metering the cooling agent or heat transfer medium 19 also balances out temperature fluctuations in the process gas 4. The temperature of the process gas 5 exiting the pre-cooler 1 can thereby be held constant. This results in an improved operating performance in all heat exchangers 1, 2, 3, and hence increases the performance of the entire cryocondensation system.

After pre-cooled in the pre-cooler 1, the process gas is cooled down even further to a specific temperature in cooler 2, so as to obtain a second condensate 9 with a defined composition. The gaseous nitrogen 12, 14 exiting the freezer is used as the coolant. Similarly to the method described above in conjunction with the pre-cooler 1, a cooling agent or heat transfer medium 13, e.g., warm gaseous nitrogen, is added to the coolant stream 12 in cooler 2 as well, so as to set a specific process gas temperature in cooler 2.

As an alternative and/or in addition to supplying the cooling agent or heat transfer medium 13, it is possible to again just route a partial stream 15 of the coolant stream 14 through the cooler 2, and relay the remaining partial stream 16 past the cooler 2 via a bypass.

Hence, the process gas temperature is also regulated in cooler 2 via the temperature and/or quantity of additionally supplied cooling agent or heat transfer medium 13 and/or by splitting the coolant stream 14 into partial streams 15, 16.

The condensate 9 produced from the process gas 5 via condensation in the cooler 2 is removed from the cooler 2 and accumulated in a second condensate container.

The process gas 6 is cooled to its lowest temperature and condensate 10 is obtained in freezer 10. Liquid or refrigerated gaseous nitrogen is used as the coolant 11. The process gas temperature in the freezer 3 depends on the requirements placed on the composition of the purified process gas 7 and/or the composition of the condensate 10. The set process temperature in the freezer 3 is maintained via the quantity and/or temperature of metered coolant 11.

The condensate 10 is removed from the freezer 3 and accumulated separately from the condensates 8, 9 in a third condensate container not shown in the drawing.

In the fractionated cryocondensation process according to the invention, the temperature of the process gas 5, 6, 7 is precisely set in the three heat exchangers 1, 2, 3 by metering cooling agent or heat transfer media 11, 13, 19 and/or bypassing the coolant streams 16, 22. The composition of the obtained condensates 8, 9, 10 depends on the set process gas temperature in the heat exchangers 1, 2, 3. The condensates 8, 9, 10 can in this way be obtained in the required level of purity, without taking any further purification steps at some other point. To this end, the condensates 8, 9, 10 are accumulated separately from each other in three different condensate containers.

### Exemplary Embodiment

A process gas containing water, vinyl acetate, ethylene and nitrogen in the composition specified below is to be separated via fractionated cryocondensation in such a way as to provide high-purity vinyl acetate and ethylene. In order to directly reuse the two components vinyl acetate and ethylene, the vinyl acetate must be present in the respective condensate with at least 96 mass % and the ethylene with at least 99 mass %.

The process gas has the following composition:

| Material | | Freezing | |
|---|---|---|---|
| component | Boiling point at 1 bar (a) | point | Mass % |
| Water | +100° C. | 0° C. | 2% |
| Vinyl acetate | +73° C. | −100° C. | 25% |
| Ethylene | −104° C. | −169° C. | 72% |
| Nitrogen | −196° C. | −210° C. | 1% |

In order to achieve the prescribed purity levels for vinyl acetate and ethylene in the respective condensates 8, 9, 10, a precisely defined process gas temperature must be set in the respective three heat exchangers 1, 2, 3. The obtained condensates 8, 9, 10 are then accumulated separately from each other in three condensate containers.

In the exemplary process, a process gas temperature in the freezer 3 of −135° C. is necessary, since only a total of 100 g/h of vinyl acetate and ethylene can legally be emitted in the process gas 7.

For comparison purposes, the cryocondensation process will first be performed without metering in additional cooling agent/heat transfer media 13, 19 and without bypass circuits 16, 22. The following temperatures are here established for the process gas 5, 6, 7 in the heat exchangers 1, 2, 3, along with the following compositions for the condensates 8, 9, 10:

| | Temperature in ° C. | Condensate in mass % |
|---|---|---|
| Heat exchanger | process gas | vinyl acetate, ethylene |
| Pre-cooler (1) | +20.4 | <0.1 vinyl acetate + ethylene |
| Cooler (2) | −44.0 | 92.7 vinyl acetate |
| Freezer (3) | −135.0 | 98.6 ethylene |

In this cryocondensation process, neither the vinyl acetate nor the ethylene are present in the condensates 8, 9, 10 at the necessary purity level of at least 96% or at least 99%, which would be required for reusing the two components. For this reason, all condensates 8, 9, 10 must be purified again or disposed of.

According to the invention, liquid nitrogen 19 and warm, gaseous nitrogen 13 are now selectively metered into the coolant streams 18, 12 so as to specifically set the process gas temperature in the pre-cooler 1 and cooler 2. The following table shows the process gas temperatures set in the pre-cooler 1, cooler 2 and freezer 3, along with the purities of the condensates 8, 9, 10 obtained in this method.

| | Temperature in ° C. | Condensate in mass % |
|---|---|---|
| Heat exchanger | process gas | vinyl acetate, ethylene |
| Pre-cooler (1) | +6.8 | <7.7 vinyl acetate, <0.1 ethylene |
| Cooler (2) | −49.7 | 96.0 vinyl acetate |
| Freezer (3) | −135.0 | 99.1 ethylene |

Precisely setting the temperature according to the invention in each heat exchanger 1, 2, 3 makes it possible to recover of 99% of the quantity of vinyl acetate and ethylene contained in the process gas at the necessary purity level, and feed it directly back to the further production process. In the exemplary process illustrated above, only gaseous and liquid nitrogen is used as the coolant stream 11 or cooling agent/heat transfer medium 13, 19, so that the gaseous nitrogen 24 exiting the pre-cooler 1 can be completely reused, e.g., for intertization. This reduces the operating costs for this cryocondensation process.

The cooled process gas 7 exiting the freezer 3 can also be used as a cooling agent for the cooler 2 and/or pre-cooler 1. If needed, other cooling agents/heat transfer media 13, 19 can be metered in. However, since the process gas stream 7 still contains residual contaminants, the coolant stream 24 withdrawn at the pre-cooler 1 can then as a rule not be further used for intertization.

If the condensate 8, 9, 10 obtained in the heat exchangers 1, 2, 3 already satisfies the purity requirements in an existing cryocondensation process, fractionated cryocondensation according to the invention makes it possible to maximize the condensate quantities 8, 9, 10 to be routed back to the production process. This is possible, since both the condensate compositions and the condensate quantities can be controlled via the adjustable process gas temperature in the heat exchangers 1, 2, 3.

If the returned condensate 8, 9, 10 contains components that act inert during the production process, these components will become enriched in the process gas. In this case, the inert gas percentage of the nitrogen in the process gas stream can be reduced to ensure a constant overall percentage of inert gas.

The fractionated cryocondensation process according to the invention is particularly efficient when the condensed and reusable components of the process gas are high in quality, and the nitrogen used as the coolant can be recycled completely.

The invention has the following essential advantages relative to the known cryocondensation process.

In the cryocondensation process according to the invention, the process temperature in the individual heat exchangers, i.e., in the pre-cooler, the cooler and freezer, can be set in a specific manner by metering in cooling agent/heat transfer media or by suitably bypassing partial streams of coolant.

The regulation concept for maintaining the process gas temperature by metering in cooling agents/heat exchanger media is simple in design, since regulation takes place only via a respective heat exchanger.

Specific condensate compositions are achieved in the individual heat exchangers by precisely setting the process gas temperature in the heat exchanger.

The volatile components contained in the process gas are separated from each other and accumulated in separate condensate containers, which is extremely complicated or even impossible using other methods, e.g., adsorption or membrane processes.

The volatile components of the process gas stream are recovered with high purity levels, and can be returned directly to the production process without any further purification steps. If the volatile components already exhibit the required purity in the condensates when using the conventional method, precisely setting the temperature in the process gas in the heat exchangers according to the invention makes it possible to maximize the condensate quantity for each volatile component. This significantly increases the efficiency of the cryocondensation process.

The process gas is purified according to legal provisions while simultaneously separating the material components contained in the process gas at a high level of purity.

The area of application for cryocondensation is expanded according to the invention, and can take the place of other separating methods, such as adsorption or membrane processes.

The efficiency of existing cryocondensation processes is increased, since the reusable condensate quantities with highly pure material components increase, without the necessity for expensive purification.

If only nitrogen is used as the cooling agent/heat transfer medium, it can be completely recycled, e.g., used for intertization, thereby holding down the operating costs of the cryocondensation system.

If condensate recovery results in an enrichment of inert components in the process gas, the percentage of nitrogen in the process gas can be reduced to keep the overall percentage of inert gas in the process gas constant.

Temperature fluctuations in the process gas are balanced out by setting the temperature in the first heat exchanger, i.e., the pre-cooler 1 in the aforementioned example. The specific and constant process gas temperature after the first heat exchanger increases the performance of the following heat exchangers, and hence the performance of the overall cryocondensation process.

Independently setting the process gas temperature for each individual heat exchanger makes it possible to influence ice formation in the heat exchangers. As a result, the quantity of forming ice can be specifically distributed to the heat exchangers, thereby extending the service life of the cryocondensation system.

The flexibility of existing cryocondensation systems is increased, since the performance of the individual heat exchangers can be specifically controlled by metering in additional cooling agents/heat transfer media. The cryocondensation system can more easily be adjusted to various operating conditions with different process gases.

What we claim is:

1. A method for cooling and/or purifying a process gas,
wherein the process gas is pre-cooled in a cooler, while undergoing indirect heat exchange with a second coolant stream, wherein condensate arising in the cooler is removed from the cooler,
and wherein the process gas exiting the cooler is cooled in a freezer, while undergoing indirect heat exchange with a first coolant stream,
wherein condensate arising in the freezer is removed from the freezer,
and wherein at least a portion of the first coolant stream exiting the freezer is routed to the cooler to form at least a portion of the second coolant stream, characterized in that
the second coolant stream is regulated in such a way as to keep a preset process gas temperature in the cooler, and to
accumulate the condensate removed from the cooler and condensate removed form the freezer separately from each other.

2. The method according to claim 1, characterized in that
wherein the process gas is pre-cooled in a pre-cooler, while undergoing indirect heat exchange with a third coolant stream,
wherein condensate arising in the pre-cooler is removed from the pre-cooler,
and wherein the process gas exiting the pre-cooler is routed to the cooler,
and wherein at least a portion of the second coolant stream exiting the cooler is routed to the pre-cooler to form at least a portion of the third coolant stream,
and wherein the third coolant stream is regulated in such a way as to keep a preset process gas temperature in the pre-cooler.

3. The method according to claim 1, characterized in that a cooling agent or heat transfer medium is supplied to the cooler and/or the pre-cooler, and the process gas is cooled while undergoing an indirect heat exchange with the cooling agent or heat transfer medium.

4. The method according to claim 3, characterized in that the cooling agent or heat transfer medium forms part of the second and/or third coolant stream.

5. The method according to claim 1, characterized in that a portion of the first coolant stream exiting the freezer is routed by the cooler via a bypass.

6. The method according to claim 1, characterized in that a portion of the second coolant stream exiting the cooler is routed by the pre-cooler via a bypass.

7. The method according to claim 1, characterized in that condensate arising in the pre-cooler is removed from the pre-cooler, and that the condensate removed from the pre-cooler, the condensate removed from the cooler and the condensate removed from the freezer are accumulated separately.

8. The method according to claim 1, characterized in that process gas removed from the cooler and/or the freezer is supplied to the cooler and/or the pre-cooler as a cooling agent or heat transfer medium.

9. The method according to claim 1, characterized in that the process gas temperatures prescribed for the pre-cooler and/or the cooler are selected in such a way that ice forming in the pre-cooler and/or the cooler and the freezer is specifically distributed to the pre-cooler and/or the cooler and the freezer.

10. The method according to claim 1, characterized in that liquid nitrogen is used as the first coolant stream.

11. A device for cooling and/or purifying a process gas, comprising
a cooler designed as an indirect heat exchanger with a process gas feed line and process gas discharge line, and with a coolant feed line and coolant discharge,
a freezer designed as an indirect heat exchanger with a process gas feed line and process gas discharge line, and with a coolant feed line and coolant discharge,
wherein the process gas discharge line of the cooler is connected with the process gas feed line of the freezer,
wherein the coolant discharge of the freezer is connected with the coolant feed line of the cooler, characterized in that
the freezer and cooler are provided with a condensate discharge line for removing condensate that arises in the freezer or in the cooler,
wherein the condensate discharge line of the freezer is connected with a first condensate container, and the condensate discharge line of the cooler is connected with a second condensate container.

12. The device according to claim 11, characterized in that
a pre-cooler designed as an indirect heat exchanger with a process gas feed line and a process discharge line, and with a coolant feed line and a coolant discharge is provided,
the pre-cooler is provided with a condensate discharge line for removing condensate that forms in the pre-cooler,
wherein the condensate discharge line of the pre-cooler is provided with a third condensate container.

13. The device according to claim 11, characterized in that a bypass around the cooler that connects the coolant feed line of the cooler and the coolant discharge of the cooler is provided and/or a bypass around the pre-cooler that connects the coolant feed line of the pre-cooler and the coolant discharge of the pre-cooler is provided.
